(19) United States
(12) Patent Application Publication
(10) Pub. No.: US 2013/0202904 A1
(43) Pub. Date: Aug. 8, 2013

(54) Sealable Polypropylene Films With Enhanced Stability

(71) Applicants: Eric T. GOHR, Midwest City, OK (US); Richard V. GEBBEN, Webster, NY (US); Lindsay J. MENDES, Fairport, NY (US)

(72) Inventors: Eric T. GOHR, Midwest City, OK (US); Richard V. GEBBEN, Webster, NY (US); Lindsay J. MENDES, Fairport, NY (US)

(73) Assignee: ExxonMobil Chemical Company - Law Technology, Baytown, TX (US)

(21) Appl. No.: 13/712,383

(22) Filed: Dec. 12, 2012

Related U.S. Application Data
(60) Provisional application No. 61/593,972, filed on Feb. 2, 2012.

(51) Int. Cl. B32B 27/28

(52) U.S. Cl. CPC B32B 27/28
USPC 428/515; 414/800

(57) ABSTRACT

A multi-layered sealable film and method of storing and transporting a role of the film without buckling or starring, the film comprising a core layer comprising polypropylene sandwiched between at least a first and (optionally) second tie-layer on either side of the core; a sealable layer with two sides, one side adhered to the first tie-layer; wherein at least the first tie-layer comprising a blend of polypropylene and within the range of from 5 wt % to 40 wt % of a soft polymer additive, preferably a propylene-α-olefin elastomer having within the range of from 10 wt % to 30 wt % α-olefin derived units, wherein the blend is preferably partially or completely immiscible. A roll of the inventive films can be readily stored and transported without loss due to film defects.

### CROSS-REFERENCE TO RELATED APPLICATION

This application claims the benefit of and priority to U.S. Ser. No. 61/593,972, filed Feb. 2, 2012, which is incorporated by reference.

### FIELD OF THE INVENTION

The present invention relates in general to sealable films having improved roll stability, and more particularly to sealable oriented polypropylene films that have improved roll stability during transport and/or storage and capable of being metallized.

### BACKGROUND

Sealable polypropylene films are known and highly useful for wrapping and storing articles such as food items. Certain sealable films are necessary in applications that require a higher level of sealability than typical oriented polypropylene (OPP) sealable films, usually measured by the package's seal strength and/or resistance to leakage. The high seal strength is desirable in applications where better structural integrity is required to preserve the freshness of the food packaged within. In many cases, these foods are dry powders and mixes that also require some barrier protection in the form of a vacuum deposited aluminum layer on the side opposite the sealant side.

In order to improve the sealability of a typical OPP film that has a heat sealable layer like a terpolymer (e.g., C₂/C₃/C₄ terpolymer), the layers beneath the sealant layer are often a blend of polypropylene and a “soft” polymer additive such as a plastomeric or elastomeric resin. See U.S. Patent Application Publication Nos. 2011/0129681; 2003/0211350; and U.S. Pat. No. 7,537,829. The plastomer resin provides a degree of conformability, which results in enhanced seal strength. This is described, for example, by Pellingra et al. in U.S. Pat. No. 7,537,829 as follows: “The seal strength is enhanced by reducing the modulus of the core and tie-layers and improving the melt or flow characteristics of these layers during sealing. Decreasing the melt temperature of the layers, including particularly the tie-layer, may increase the degree of entanglement and intermingling of the adjacent layers. Thus, the layers enjoy improved bonding, delamination and destruction resistance, and improved flowing in seal folds or creases, thereby effecting improved seal strength while simultaneously facilitating a reduced frequency of leak-paths in critical seal areas, such as seal corners, folds or creases. The reduced modulus or improved elasticity of the film permits improved diffusion throughout the layers of forces or stresses applied to the seal, thereby facilitating improved seal strength.” (col. 3, 1. 28-42).

Additionally, it is proposed in the patents and publications referenced above that the sealant layer and the layers below it containing the “soft” polymer components act synergistically to dissipate the seal stress through improved plastic deformation or compliance.

Typical plastomer components that have been used in the past are heterophasic impact copolymers, block copolymers, random copolymers, and terpolymers based on C₂ to C₈ α-olefins polymerized using a variety of technologies based on Ziegler-Natta or metallocene catalysts. Additionally, other elastomeric polymers with a rubber phase have also been used in blends with polypropylene tie-layers. See U.S. Patent Application Publication Nos. 2009/0136698; 2007/0082154; and 2008/0145670. In all cases, the soft polymer additives have been specified by a few key properties that link to seal performance, such as melting point range, Vicat softening point, and flexural modulus. While these properties are adequate in specifying resins to produce films with good sealing characteristics, they are often inadequate to determine roll stability especially for films that are metallized with a layer of vacuum deposited aluminum.

The inventors have found that proper selection of the “soft” polymer additive is vital in order to mitigate roll defects like starring and Transverse Direction (TD) buckles. These defects often result due to higher complex modulus variation with temperature in the plastomer or elastomer, lower rate of crystallization of the blend (this refers to the retardation of the crystallization rate of the polypropylene homopolymer when the soft polymer co-crystallizes with the homopolymer), and higher degree of miscibility with the major polypropylene homopolymer phase. For instance, process conditions used in a metallization chamber can result in higher quality losses for starring when using a plastomer/elastomer with a higher modulus variation with temperature.

Additionally, if the polymer is more miscible with the polypropylene homopolymer phase and crystallizes slower (again results in an overall retardation of crystallization rate of the blend), the secondary crystallization resulting while the film is being mill-rolled or stored as a mill-roll (or simply “roll”), and requires additional aging of the roll before it can be slit. This is to ensure that the roll is stable and prevents the generation of more quality defects like those described above. The quality defects and additional hold time add to loss of productivity and higher production costs. This is especially critical for films that cannot be reground and reprocessed. The inventors have found a desirable combination of soft polymer additive with polypropylene in sealable films that does not exhibit the quality defects of the current state of the art.

Other disclosures include U.S. Pat. No. 8,075,985; U.S. Patent Application Publication Nos. 2010/0125114; 2011/0143057; 2011/0135916; 2010/0260996; and 2007/0287007.

### SUMMARY

The invention described herein includes a multi-layered sealable film comprising a core layer comprising polypropylene sandwiched between at least a first and, optionally, a second tie-layer, on either side of the core; a sealable layer with two sides, one side adhered to the first tie-layer; and wherein at least the first tie-layer comprises a blend of polypropylene and within the range of from 5 wt % or 10 wt % to 20 wt % or 30 wt % or 40 wt % of a soft polymer additive, by weight of the first tie-layer, wherein the blend of polypropylene and soft polymer additive is a heterogeneous blend characterized in having two glass transition temperatures (Tg) that are within the range of from −60° C. or −50° C. or −40° C. to −10° C. or 0° C. or +10° C. or +20° C. or +30° C.

The invention described is preferably a multi-layered sealable film comprising a core layer comprising polypropylene having at least a first tie-layer adjacent thereto, and most preferably a core layer sandwiched between at least a first tie-layer and a second tie-layer on either side of the core; and a sealable layer with two sides, one side adhered to the first tie-layer; wherein at least the first tie-layer comprising a blend of polypropylene and within the range of from 5 wt % or 10 wt % to 20 wt % or 30 wt % or 40 wt % of a propylene-α-olefin elastomer, by weight of the first tie-layer, having within the range of from 10 wt % or 12 wt % or 14 wt % to 25 wt % or 30 wt % α-olefin derived units.

The invention described herein also includes a method of transporting film comprising the inventive film as described herein; rolling the film onto a spool to form a roll; loading the roll onto a transport vehicle at a geographic starting point; transporting the roll to a second geographic point, wherein the temperature change from the starting point to the second point is at least 5° C.; and unloading the roll at the second point having no starring or buckling.

### BRIEF DESCRIPTION OF THE DRAWINGS

FIG. 1(a) is a visual image of an end view of the comparative film showing the scalloped or starred appearance of the film.

FIG. 1(b) is a pictorial representation of side view of the comparative film showing the scalloped or starred appearance of the film in FIG. 1(a).

FIG. 2 is a graphical depiction of the relationship of radial pressure and circumferential stress as a function of the radius of the film that exists in a roll of film.

FIG. 3 is a graphical depiction of the percent crystallization measurements for the inventive and comparative elastomer/polypropylene mixtures and films.

FIGS. 4(a)-4(c) are graphical depictions of the tangent delta (tan δ) determinations using DMTA of inventive and comparative film compositions.

FIG. 5 is a graphical representation of the seal strength of the inventive and comparative films as a function of temperature.

FIGS. 6(a)-6(d) are graphical representations of sealability of inventive and comparative films using Lako flat jaws and Wrapade Crimp seal testers.

FIG. 7 is a graphical representation of the seal strength of films with varying amounts of the high α-olefin elastomer present in the tie-layer.

### DETAILED DESCRIPTION

The inventors have found a surprising combination of certain soft polymer additive(s) in multi-layered sealable films that improve its roll stability (prevent buckling and starring) while maintaining strong sealability. The inventors have found that these defects are often the result of higher complex modulus variation with temperature in the soft polymer additive, lower rate of crystallization, and higher degree of miscibility with the major polypropylene homopolymer phase in prior art multi-layered sealable films. To improve stability of the film, a soft polymer that is preferably partially or completely immiscible with polypropylene is desirably used in at least one layer of the multi-layered films of the invention. Most preferably, the soft polymer and the polypropylene is a heterogeneous mixture used in at least one tie-layer adjacent to the core. The inventors have found a class of propylene-α-olefin elastomers particularly preferred soft polymers.

Thus, provided in the present invention are multi-layered sealable films comprising at least three layers, most preferably a skin/tie-layer/core or skin/tie-layer/core/tie-layer structure. The films of the invention comprise at least a core layer comprising polypropylene and a first and optionally a second tie-layer on either side of the core; a sealable layer with two sides, one side adhered to the first tie-layer which may be exposed to the environment on its other side, or bound to a substrate or other film layer; wherein at least the first tie-layer comprises a blend of polypropylene and within the range of from 5 wt % to 40 wt % of a soft polymer additive, and ranges there between, wherein the blend is a heterogeneous blend characterized in having two glass transition temperatures (Tg) that are within the range of from −60° C. to +30° C., and ranges there between.

The “soft polymer additive” may be any polymeric material or blend of materials that is partially or completely immiscible with isotactic polypropylene as characterized by demonstrating two temperature transitions in a Dynamic Mechanical Thermal Analysis (DMTA) plot, described further below. Preferably, the soft polymer additive has a melting point Differential Scanning Calorimetry (“DSC”, ASTM D3418) of less than 115° C. or 110° C. or 100° C. or 90° C. or 80° C.; or more preferably within the range of from 10° C. or 15° C. or 20° C. or 25° C. to 65° C. or 75° C. or 80° C. or 95° C. or 105° C. or 110° C. or 115° C. Preferably, the soft polymer additive has a glass transition temperature (Tg) within the range of from −50° C. or −40° C. to −10° C. or 0° C. In certain embodiments, the soft polymer additive has no discernable melting point but is better described by its Vicat softening temperature. Whether the polymer has a melting point or not, the soft polymer additive preferably has a Vicat softening temperature (ISO 306, or ASTM D 1525) of less than 120° C. or 110° C. or 105° C. or 100° C., or within a range of from 50° C. or 60° C. to 110° C. or 120° C., or a very particular range of from 70° C. or 80° C. to 100° C. or 110° C. Preferably, the soft polymer additive has a heat of fusion (H_{f}), determined according to the DSC procedure described below, within the range of from 0.5 J/g or 1 J/g or 5 J/g to 35 J/g or 40 J/g or 50 J/g or 65 J/g or 75 J/g. Preferably, the H_{f} value is less than 75 J/g or 60 J/g or 50 J/g or 40 J/g. In a most preferred embodiment, the soft polymer additive is a propylene-α-olefin elastomer, described further below.

Preferably, the inventive films comprise tie-layers on either side of the core layer that are asymmetric, meaning that the content (polymers) of the tie-layers are not the same in amounts and/or identity, and in a most preferred embodiment means that the soft polymer additive or propylene-α-olefin elastomer is only present in the first tie-layer and not the second tie-layer. In a most preferred embodiment of the invention, soft polymer additive or propylene-α-olefin elastomers are substantially absent from the second tie-layer.

Desirably, the second tie-layer is also adjacent to a metal-accepting skin layer. In preferred embodiments, the metal-accepting skin layer comprises a polar-functionalized polymer. The metal-accepting skin layer(s) of the multi-layer polymeric films herein may contain one or more copolymers comprising propylene and butylene, preferably a random propylene-butylene copolymer, and/or one or more terpolymers of ethylene, propylene, and butylene. Other desirable materials that can make up the metal-adhering skin layer include those with polar groups such as ethylene vinyl acetate copolymers, ethylene vinyl alcohol (EvOH) polymers, and graft polymers such as maleic anhydride-grafted polyolefins. Commercial examples of suitable metal-accepting skin layer components include Eval G176B (Kuraray) and Vistamaxx propylene-based elastomers, and blends of these components with polypropylene or polyethylene.

The metallizable skin layer(s) may also include (or consist essentially of) other types of polymeric materials, including homopolymers, other copolymers and other terpolymers, in addition to the copolymers and/or terpolymers discussed previously that are present. Such optional polymeric components of the metallizable skin layer(s) herein include polyethylene, polypropylene, and other thermoplastic materials such as polyamides, polyesters, polyvinyls, polylactics, as well as co- and terpolymers of ethylene and ethylenically unsaturated carboxylic acids. Though not often preferred, the skin layer may also optionally contain other particulate components if desired, such as fillers, pigments, antiblocks, other agents that might produce a desired surface effect on the metallized skin layer, such as a matte-like metallized surface.

In a most preferred embodiment of the invention, a layer, such as the core layer, may consist essentially of the named polymer components. By “consisting essentially of” what is meant is that the film or layer referred to only includes as effective polymer components the named polymers but can also include up to 1 wt % or 2 wt % or 3 wt % or 4 wt % or 5 wt % of an additive as described further below, those additives not changing the properties of the film or layer as claimed. In other most preferred embodiments, the films and/or layers consist of the named polymer components.

Preferably, the films of the invention have at least 3 layers, and more preferably at least 4 layers, and most preferably at least 5 layers. The films typically have one, and more preferably at least two skin layers that are bound to a tie-layer on one face, and are unbound (face away from the multi-layer film) on the other face. In other embodiments, there is a tie-layer between each core layer and each skin layer that are otherwise adjacent to one another in the structure. If each skin layer is labeled “S”, each core layer labeled “C”, and each tie-layer labeled “T”, then preferable film structures include, but are not limited to, STC, STCT, STCS, STCTS, SSTCTS, STSCTSTS, SSTCCTSS, STSTCCTSTS, STTCTTS, SSSTCTS, SSTCTS, and other such structures. In the films described herein, each individual skin layer may be the same or different, preferably the same, in composition compared to other skin layers in the same film. Also, each core layer may be the same or different, and each tie-layer may be the same or different. Thus, for example, preferable film structures are represented by S¹T¹C, S¹T¹CT2_{, S}¹T¹CT²S², S¹S²T¹CT²S¹, etc., wherein “S¹” and “S²” are distinct from one another, meaning that they comprise different materials, and/or the same materials but in different ratios. The same is true for “T¹” and “T²”. However, each skin layer, tie-layer, and core layer that makes up a film may have a similar or identical identity, as this type of structure allows the use of only three extruders to melt blend and extrude the materials that form each layer of the film.

As used herein, the term “layer” refers to each of the one or more materials, the same or different, that are secured to one another in the form of a thin sheet or film by any appropriate means such as by an inherent tendency of the materials to adhere to one another, or by inducing the materials to adhere as by a heating, radiative, chemical, or some other appropriate process. The term “layer” is not limited to detectable, discrete materials contacting one another such that a distinct boundary exists between the materials. Preferably, however, the materials used to make one layer of a film will be different (i.e., the weight percent of components, the properties of each component, and/or the identity of the components may differ) from the materials used to make an adjacent, and adhering, layer. The term “layer” includes a finished product having a continuum of materials throughout its thickness. The “films” described herein comprise three or more layers, and may comprise 3, 4, 5, 6, or more layers in preferred embodiments.

The 3, 4, 5, 6, or more layer film structures (films) of the invention may be any desirable thickness, and preferably have an average thickness within the range of from 20 μm or 30 μm or 40 μm to an upper limit of 50 μm or 60 μm or 80 μm or 100 μm or 150 μm or 200 μm or 500 μm. Thus, an exemplary average thickness is within the range of from 30 μm to 80 μm.

Core Layer. The “polypropylene” that is preferably used in the core and other layers is a homopolymer or copolymer comprising from 60 wt % or 70 wt % or 80 wt % or 85 wt % or 90 wt % or 95 wt % or 98 wt % or 99 wt % to 100 wt % propylene-derived units; comprising within the range of from 0 wt % or 1 wt % or 5 wt % to 10 wt % or 15 wt % or 20 wt % or 30 wt % or 40 wt % C₂ and/or C₄ to C₁₀ α-olefin derived units; and can be made by any desirable process using any desirable catalyst as is known in the art, such as a Ziegler-Natta catalyst, a metallocene catalyst, or other single-site catalyst, using solution, slurry, high pressure, or gas phase processes. Polypropylene copolymers are useful polymers in certain embodiments, especially copolymers of propylene with ethylene and/or butene, and comprise propylene-derived units within the range of from 70 wt % or 80 wt % to 95 wt % or 98 wt % by weight of the polypropylene. In any case, useful polypropylenes have a DSC melting point (ASTM D3418) of at least 125° C. or 130° C. or 140° C. or 150° C. or 160° C., or within a range of from 125° C. or 130° C. to 140° C. or 150° C. or 160° C. A “highly crystalline” polypropylene is preferred in certain embodiments of the inventive films, and is typically isotactic and comprises 100 wt % propylene-derived units (propylene homopolymer) and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter- and intra-molecular order. Preferably, the polypropylene has a heat of fusion (H_{f}) greater than 60 J/g or 70 J/g or 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer. Also, the polypropylenes useful in the inventive films may have a glass transition temperature (ISO 11357-1, Tg) preferably between −20° C. or −10° C. or 0° C. to 10° C. or 20° C. or 40° C. or 50° C. Preferably, the polypropylenes have a Vicat softening temperature (ISO 306, or ASTM D 1525) of greater than 120° C. or 110° C. or 105° C. or 100° C., or within a range of from 100° C. or 105° C. to 110° C. or 120° C. or 140° C. or 150° C., or a particular range of from 110° C. or 120° C. to 150° C.

Preferably, the polypropylene has a melt flow rate (“MFR”, 230° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0 in certain embodiments. Suitable grades of polypropylene that are useful in the oriented films described herein include those made by ExxonMobil, LyondellBasell, Total, Borealis, Japan Polypropylene, Mitsui, and other sources. Particular examples of preferred commercially available resins include: XPM-7794 and XPM-7510 both C₂/C₃/C₄ terpolymers available from Japan Polypropylene Corp; EP-8573 a C₃/C₂ copolymer available from Total Petrochemical Company; PB0300M and Adsyl™ 3C30FHP available from LyondellBasell.

Propylene-α-olefin Elastomers. Preferably, the soft polymer additive is a propylene-α-olefin elastomer. As used herein, a “propylene-α-olefin elastomer” refers to a random copolymer that is elastomeric, has moderate crystallinity and possesses propylene-derived units and one or more units derived from ethylene, higher α-olefins, and/or optionally diene-derived units. One or a mixture of different propylene-α-olefin elastomers may be present in the core compositions, preferably only one. The propylene-based elastomers are copolymers of propylene having an intermediate amount of α-olefin, such as within a range of from 10 wt % or 12 wt % or 14 wt % to 25 wt % or 30 wt % α-olefin derived units by weight of the polymer. In some instances herein, such a propylene-α-olefin elastomer is called a “high α-olefin elastomer,” especially when comparing it to another elastomer having a lower amount of comonomer. In a particular embodiment, where more than one comonomer is present, the amount of a particular comonomer may be less than 10 wt %, but the combined comonomer content is greater than 10 wt %. The propylene-α-olefin elastomers may be described by any number of different parameters, and those parameters may comprise a numerical range made up of any desirable upper limit with any desirable lower limit as described herein.

Preferably, the propylene-α-olefin elastomer comprises C₂ or C₄ to C₁₀ α-olefin-derived units (or “comonomer-derived units”) within the range of 10 wt % or 12 wt % or 14 wt % to 25 wt % or 30 wt %, by weight of the elastomer. The propylene-α-olefin elastomer may also comprise two different comonomer-derived units. Also, these copolymers and terpolymers may comprise diene-derived units as described below. Preferably, the propylene-α-olefin elastomer comprises propylene-derived units and comonomer units selected from ethylene, 1-butene, 1-hexene, and 1-octene. And, more preferably, the comonomer is ethylene and, thus, the propylene-α-olefin elastomer is a propylene-ethylene copolymer. When dienes are present, the propylene-α-olefin elastomer comprises less than 5 wt % or 3 wt %, by weight of the elastomer, of diene derived units, or within the range of from 0.1 wt % or 0.5 wt % or 1 wt % to 5 wt % in other embodiments. Suitable dienes include, for example: 1,4-hexadiene; 1,6-octadiene; 5-methyl-1,4-hexadiene; 3,7-dimethyl-1,6-octadiene; dicyclopentadiene (DCPD); ethylidiene norbornene (ENB); norbornadiene; 5-vinyl-2-norbornene (VNB); and combinations thereof.

These propylene-α-olefin elastomers may have some isotactic polypropylene sequences but they also have some amorphous regions in the polymer chains, thus imparting desirable qualities to them and the compositions in which they are blended. Preferably, the propylene-α-olefin elastomers have a melting point (DSC) of less than 115° C. or 110° C. or 100° C. or 90° C. or 80° C.; or more preferably within the range of from 10° C. or 15° C. or 20° C. or 25° C. to 65° C. or 75° C. or 80° C. or 95° C. or 105° C. or 110° C. or 115° C. In certain embodiments, the propylene-α-olefin elastomers have no discernable melting point but are better described by their Vicat softening temperature. Whether the copolymers have a melting point or not, the propylene-α-olefin elastomers preferably have a Vicat softening temperature (ISO 306, or ASTM D 1525) of less than 120° C. or 110° C. or 105° C. or 100° C., or within a range of from 50° C. or 60° C. to 110° C. or 120° C., or a very particular range of from 70° C. or 80° C. to 100° C. or 110° C. Preferably, the softening point of the polypropylene is at least 5° C. or 10° C. or 15° C. or 20° C. higher than the softening point of the propylene-α-olefin elastomers used as an additive.

Preferably, the propylene-α-olefin elastomers have an H_{f}, determined according to DSC, within the range of from 0.5 J/g or 1 J/g or 5 J/g to 35 J/g or 40 J/g or 50 J/g or 65 J/g or 75 J/g. In certain embodiments, the H_{f} value is less than 75 J/g or 60 J/g or 50 J/g or 40

J/g. Preferably, the propylene-α-olefin elastomers have a percent crystallinity within the range of from 0.5% to 40%, and from 1% to 30% in another embodiment, and from 5% to 25% in yet another embodiment, wherein “percent crystallinity” is determined according to the DSC procedure described herein. The thermal energy for the highest order of polypropylene is estimated at 189 J/g (i.e., 100% crystallinity is equal to 189 J/g). Preferably, the propylene-α-olefin elastomers have a glass transition temperature (Tg) within the range of from −50° C. or −40° C. to −10° C. or 0° C.

Preferably, the propylene-α-olefin elastomers have a melt flow rate (“MFR,” ASTM D1238, 2.16 kg, 230° C.), within the range of from 0.5 g/10 min or 1 g/10 min or 1.5 g/10 min or 2 g/10 min to 4 g/10 min or 6 g/10 min or 12 g/10 min or 16 g/10 min or 20 g/10 min in other embodiments.

Preferably, the molecular weight distribution (Mw/Mn, MWD) of the propylene-α-olefin elastomers is within the range of from 1.5 or 1.8 or 2.0 to 3.0 or 3.5 or 4.0 or 5.0. In a preferred embodiment, the propylene-α-olefin elastomer useful in the invention has a molecular weight (Mw) of greater than 170,000, or more preferably within a range of from 170,000 or 180,000 or 190,000 to 240,000 or 260,000 or 280,000 or 300,000. Techniques for determining the molecular weight (Mn, Mz, and Mw) and molecular weight distribution (MWD) are as follows and as in Verstate et al. in 21 MACROMOLECULES 3360 (1988). Conditions described herein govern over published test conditions. Molecular weight and molecular weight distribution are measured using a Waters 150 gel permeation chromatograph equipped with a Chromatix KMX-6 on-line light scattering photometer. The system was used at 135° C. with 1,2,4-trichlorobenzene as the mobile phase. Showdex (Showa-Denko America, Inc.) polystyrene gel columns 802, 803, 804, and 805 are used. This technique is discussed in LIQUID CHROMATOGRAPHY OF POLYMERS AND RELATED MATERIALS III 207 (J. Cazes Ed., Marcel Dekker, 1981).

The propylene-α-olefin elastomers described herein can be produced using any catalyst and/or process known for producing polypropylenes. Preferred methods for producing the propylene-α-olefin elastomers are found in U.S. Patent Application Publication 2004/0236042 and U.S. Pat. No. 6,881,800. Preferred propylene-α-olefin elastomers are available commercially under the trade names Vistamaxx™ (ExxonMobil Chemical Company, Houston, Tex., USA) and Versify™ (The Dow Chemical Company, Midland, Mich., USA), certain grades of Tafmer™ XM or Notio™ (Mitsui Company, Japan), or certain grades of Clyrell™ and/or Softel™ (LyondellBasell Polyolefins of the Netherlands).

Skin Layer Materials. Preferably, the one or both skin layers in the films of the invention may include (or consist essentially of, or consist of) a polymer that is suitable for heat-sealing or bonding to itself when crimped between heated crimp-sealer jaws. Desirable polymers that make up the skin layers have a DSC melting point of from 120° C. or 125° C. or 130° C. to 150° C. or 160° C., a Shore D Hardness within the range of from 55 or 56 to 65 or 70, and a Flexural Modulus (ISO 178) of at least 500 MPa or 600 MPa or 650 MPa, or in another embodiment, within the range of from 400 MPa or 500 MPa or 600 MPa to 800 MPa or 900 MPa or 1000 MPa or 1500 MPa or 2000 MPa. Commonly, suitable skin layer polymers include copolymers or terpolymers of ethylene, propylene, and butylene (EPB terpolymer, or C₂/C₃/C₄ terpolymer) and may have DSC melting points of less than 140° C. or 135° C., or within a range of from 100° C. to 135° C. or 140° C. In some preferred embodiments, the skin layers may also comprise a polymer selected from propylene homopolymer, ethylene-propylene copolymer, butylene homopolymer and copolymer, ethylene vinyl acetate (EVA), metallocene-catalyzed propylene homopolymer, polyethylene (low, linear low, medium, or high), and combinations thereof. An example of a suitable EPB terpolymer is Japan Polypropylene Corp. propylene-based terpolymer 7510. In a particular embodiment, the skin layers consist essentially of one or more propylene-ethylene copolymers or propylene-ethylene-butylene terpolymers.

Heat sealable blends of polymers can be utilized in the first, second, or both skin layers in the inventive films. Thus, along with the skin layer polymers identified above there can be, for example, other polymers, such as polypropylene homopolymer, for example, one that is the same as, or different from, the polypropylene of the core layer. The first skin layer may additionally or alternatively include materials selected from the group consisting of ethylene-propylene random copolymers, low-density polyethylene (LDPE), linear low density polyethylene (LLDPE), medium density polyethylene (MDPE), and combinations thereof.

Preferably, the first, second, or both skin layers comprise at least one polymer selected from the group consisting of a polyethylene (PE) polymer or copolymer, a polypropylene polymer or copolymer, an ethylene-propylene copolymer, an EPB terpolymer, a propylene-butylene (PB) copolymer, and combinations thereof Preferably, the PE polymer is high-density polyethylene (HDPE), such as HD-6704.67 (ExxonMobil Chemical Company) or M-6211 or HDPE M-6030 (Equistar Chemical Company). A suitable ethylene-propylene copolymer is Fina 8573 (Total). Preferred EPB terpolymers include Japan

Polypropylene 7510 and 7794 (Japan Polypropylene Corp.). For coating and printing functions, the first skin layer may preferably comprise a copolymer that has been surface treated.

The skin layer can also comprise (or consist essentially of) a styrenic block copolymer. Desirable polymer will have a density within the range of from 0.850 g/cc or 0.860 g/cc or 0.870 g/cc to 0.930 g/cc or 0.940 g/cc or 0.960 g/cc or 1.000 g/cc or 1.050 g/cc (ISO 1183). Preferably, the styrenic block copolymers comprise from 15 wt % or 20 wt % or 25 wt % to 35 wt % or 40 wt % or 45 wt % or 50 wt % styrenic derived units, by weight of the copolymer. Preferably, the styrenic block copolymer is a styrene-ethylene/butylene-styrene terpolymer having a melt flow rate (MFR, ASTM D 1238, 230° C. at 2.16 kg) of from 0.5 g/10 min or 1 g/10 min or 2 g/10 min or 3 g/10 min to 6 g/10 min or 8 g/10 min or 10 g/10 min or 12 g/10 min. Desirable styrenic block copolymers may be SEBS or SBBS Tuftec™ styrenic elastomers from Asahi Kasei Chemicals; Chevron Phillips K-Resins™; and Kraton198 D or G elastomers.

The styrenic block copolymer may comprise from 50 wt % or 60 wt % or 70 wt % to 90 wt % or 100 wt %, by weight of the skin layer materials, of the skin layer. The skin layer may consist essentially of, or consist of, the styrenic block copolymer, but when other materials are present, skin layer materials or core layer materials may make up a portion or all of the remainder. Preferably, the skin layer(s) is made from a blend of the styrenic block copolymer and the ethylene-based polymers described above, the latter being present in the skin layer within a range of from 5 wt % or 10 wt % or 20 wt % to 40 wt % or 50 wt %, by weight of the skin layer.

Additives. Additives may be present in one or more layers of the multi-layer films of this disclosure. Typically, the additives are present, if at all, at a level of from 0.1 wt % or 0.5 wt % to 1 wt % or 2 wt % or 3 wt % or 5 wt %, by weight of the materials in the given layer. In some cases, such as for cavitating or opacifying agents, the amounts can be within the range of from 5 wt % to 10 wt % or 15 wt % or 20 wt % or 30 wt %, by weight of the given layer. Examples of additives include, but are not limited to, opacifying agents, pigments, colorants, cavitating agents, slip agents, antioxidants, anti-fog agents, anti-static agents, anti-block agents, fillers, moisture barrier additives, gas barrier additives, and combinations thereof. Such additives may be used in effective amounts, which vary depending upon the application and the property desired.

Examples of suitable opacifying agents, pigments, or colorants include iron oxide, carbon black, aluminum, titanium dioxide (TiO₂), calcium carbonate (CaCO₃), polybutylene terephthalate (PBT), talc, beta nucleating agents, and combinations thereof.

Cavitating or void-initiating additives may include any suitable organic or inorganic material that is incompatible with the polymer material(s) of the layer(s) to which it is added, at the temperature of biaxial orientation, in order to create an opaque film. Examples of suitable void-initiating particles are PBT, nylon, solid or hollow pre-formed glass spheres, metal beads or spheres, ceramic spheres, calcium carbonate, talc, chalk, or combinations thereof. The average diameter of the void-initiating particles typically may be within the range of from 0.1 μm to 2 μm or 3 μm or 5 μm or 8 μm or 10 μm. Cavitation may also be introduced by beta-cavitation, which includes creating beta-form crystals of polypropylene and converting at least some of the beta-crystals to alpha-form polypropylene crystals and creating a small void remaining after the conversion. Preferred beta-cavitated embodiments of the core layer may also comprise a beta-crystalline nucleating agent. Substantially, any beta-crystalline nucleating agent (“beta nucleating agent” or “beta nucleator”) may be used.

Slip agents may include higher aliphatic acid amides, higher aliphatic acid esters, waxes, silicone oils, and metal soaps. Such slip agents may be used in amounts ranging from about 0.1 wt % to about 2 wt %, based on the total weight of the layer to which it is added. An example of a slip additive that may be useful is erucamide.

Non-migratory slip agents, used in one or more skin layers of the multi-layer films, may include polymethyl methacrylate (PMMA). The non-migratory slip agent may have a mean particle size in the range of from about 0.5 μm to about 8 μm, or about 1 μm to about 5 μm, or about 2 μm to about 4 μm, depending upon layer thickness and desired slip properties. Alternatively, the size of the particles in the non-migratory slip agent, such as PMMA, may be greater than about 20% of the thickness of the skin layer containing the slip agent, or greater than about 40% of the thickness of the skin layer, or greater than about 50% of the thickness of the skin layer. The size of the particles of such non-migratory slip agents may also be at least about 10% greater than the thickness of the skin layer, or at least about 20% greater than the thickness of the skin layer, or at least about 40% greater than the thickness of the skin layer. Generally spherical, particulate non-migratory slip agents are contemplated, including PMMA resins, such as Epostar™ (commercially available from Nippon Shokubai Co., Ltd.). Other commercial sources of suitable materials are also known to exist. “Non-migratory” means that these particulates generally do not change location throughout the layers of the film in the manner of migratory slip agents. A conventional polydialkyl siloxane, such as silicone oil or gum additive having a viscosity within the range of from 10,000 or 20,000 or 50,000 to 500,000 or 800,000 or 1,000,000 or 2,000,000 centistokes (25° C.) is also contemplated.

Suitable anti-oxidants may include phenolic anti-oxidants, such as Irganox™ 1010 (Ciba Specialty Chemicals). Such an anti-oxidant is generally used in amounts ranging from about 0.1 wt % to about 2 wt %, based on the total weight of the layer(s) to which it is added.

Anti-static agents may include alkali metal sulfonates, polyether-modified polydiorganosiloxanes, polyalkylphenylsiloxanes, and tertiary amines Such anti-static agents may be used in amounts ranging from about 0.05 wt % to about 3 wt %, based upon the total weight of the layer(s).

Examples of suitable anti-blocking agents may include silica-based products such as Sylobloc™ 44 (Grace Davison Products), PMMA particles such as Epostar (Nippon Shokubai Co., Ltd.), or polysiloxanes such as Tospearl™ (GE Bayer Silicones). Such an anti-blocking agent comprises an effective amount up to about 3000 ppm of the weight of the layer(s) to which it is added.

Fillers may include finely divided inorganic solid materials, such as silica, fumed silica, diatomaceous earth, calcium carbonate, calcium silicate, aluminum silicate, kaolin, talc, bentonite, clay, wollastonite, and pulp.

Suitable moisture and gas barrier additives may include effective amounts of low-molecular weight resins, hydrocarbon resins, particularly petroleum resins, styrene resins, cyclopentadiene resins, and terpene resins.

Optionally, one or more skin layers may be compounded with a wax or coated with a wax-containing coating, for lubricity, in amounts ranging from about 2 wt % to about 15 wt % based on the total weight of the skin layer. Any conventional wax, such as, but not limited to, Carnauba™ wax (commercially available from Michelman Corporation), and Be Square™ wax (commercially available from Baker Hughes Corporation), that is useful in thermoplastic films is contemplated.

Method of Manufacturing the Films. The inventive films are preferably biaxially oriented. The inventive films can be made and oriented by any suitable technique known in the art, such as a cast, tentered, blown process, LISIM™, and others. Further, the working conditions, temperature settings, lines speeds, etc. will vary depending on the type and the size of the equipment used. Nonetheless, described generally here is one method of making the films described throughout this specification. In a particular embodiment, the films are formed and biaxially oriented using the “tentered” method. In the tentered process, line speeds of greater than 100 m/min to 400 m/min or more, and outputs of greater than 2000 kg/hr to 4000 kg/hr or more are achievable. In the tenter process, sheets/films of the various materials are melt blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm. The extruded film is then cooled using air, water, or both. Typically, a single, large diameter roll partially submerged in a water bath, or two large chill rolls set at 20° C. or 30° C. to 40° C. or 50° C. or 60° C. or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80° C. to 100° C. or 120° C. or 150° C. in one embodiment by any suitable means such as heated S-wrap rolls, and then passed between closely spaced differential speed rolls to achieve machine direction orientation. It is understood by those skilled in the art that this temperature range can vary depending upon the equipment, and in particular, upon the identity and composition of the components making up the film. Ideally, the temperature will be below that which will melt the film, or cause it to become tacky and adhere to the equipment, but high enough to facilitate the machine direction orientation process. Such temperatures referred to herein refer to the film temperature itself The film temperature can be measured by using, for example, Infrared spectroscopy, the source aimed at the film as it is being processed; those skilled in the art will understand that for transparent films, measuring the actual film temperature will not be as precise. In this case, those skilled in the art can estimate the temperature of the film by knowing the temperature of the air or roller immediately adjacent to the film measured by any suitable means. The heating means for the film line may be set at any appropriate level of heating, depending upon the instrument, to achieve the stated film temperatures.

The lengthened and thinned film is cooled and passed to the tenter section of the line for TD orientation. At this point, the edges of the sheet are grasped by mechanical clips on continuous chains and pulled into a long, precisely controlled hot air oven for a pre-heating step. The film temperatures range from 100° C. or 110° C. to 150° C. or 170° C. or 180° C. in the pre-heating step. Again, the temperature will be below that which will melt the film or cause it to become tacky and adhere to the equipment, but high enough to facilitate the step of transverse direction orientation. Next, the edges of the sheet are grasped by mechanical clips on continuous chains and pulled into a long, precisely controlled hot air oven for transverse stretching. As the tenter chains diverge, a desired amount to stretch the film in the transverse direction, the film temperature is lowered by at least 2° C. but typically no more than 20° C. relative to the pre-heat temperature to maintain the film temperature so that it will not melt the film. After stretching to achieve transverse orientation in the film, the film is then cooled from 5° C. to 10° C. or 15° C. or 20° C. or 30° C. or 40° C. below the stretching temperature, and the clips are released prior to edge trim, optional coronal, printing, and/or other treatment can then take place, followed by winding.

Thus, TD orientation is achieved by the steps of pre-heating the film having been machine oriented, followed by stretching it at a temperature below the pre-heat temperature of the film, and then followed by a cooling step at yet a lower temperature. In one embodiment, the films described herein are formed by imparting a transverse orientation by a process of first pre-heating the film, followed by a decrease in the temperature of the film within the range of from 2° C. or 3° C. to 5° C. to 10° C. or 15° C. or 20° C. relative to the pre-heating temperature while performing transverse orientation of the film, followed by a lowering of the temperature within the range of from 5° C. to 10° C. or 15° C. or 20° C. or 30° C. or 40° C. relative to the stretching temperature, holding or slightly decreasing (by no more than 5%) the amount of stretch, to allow the film to “anneal.” The latter step imparts (reduces or minimizes) the high TD shrink characteristics of the films described herein, thus improving dimensional stability. In certain embodiments, the dimensional stability of the films described herein is within 15% or 10% or 8% at 135° C. after 5-10 minutes in either the MD or TD as otherwise measured by ASTM D1204. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Soft Polymer-Containing (First) Tie-layer. In making the films, at least one blending apparatus such as a melt extruder can be used to blend at least the polypropylene and soft polymer additive, preferably a propylene-α-olefin elastomer, to form at least the first tie-layer of the multi-layered film. The blend will comprise, or consist essentially of, within the range of from 5 wt % or 10 wt % to 20 wt % or 25 wt % or 30 wt % or 35 wt % or 40 wt % of the soft polymer additive, by weight of the first tie-layer. Preferably, only one tie-layer comprises the blend of the soft polymer additive and polypropylene. The tie-layer(s) that contain the soft polymer additive are preferably a blend with polypropylene as described herein. Preferably, the blend of polypropylene with the soft polymer additive in the first tie-layer is partially or completely heterogeneous, most preferably it is heterogeneous. The soft polymer additive or propylene-α-olefin elastomer may be present in the core layer in an amount of from 0.5 wt % to 4 wt % or 6 wt % or 10 wt %, but preferably the amount of soft polymer additive present in the core layer is less than 5 wt % or 3 wt % or 1 wt %. Most preferably, soft polymer additive is substantially absent from the core layer.

The blend of the polypropylene and soft polymer additive has certain desirable properties, and preferably crystallizes completely and relatively rapidly. In a preferred embodiment, the crystallinity of the blend of polypropylene and soft polymer additive in the tie-layer is within the range of from 20% or 22% or 24% or 26% to 30% or 32% or 34% or 36%. Furthermore, the blend of polypropylene and soft polymer additive in the tie-layer preferably has one glass transition temperature (ISO 11357-1, Tg) that is within the range of from −50° C. or −40° C. to −10° C. or 0° C. or +10° C. or +20° C. Most preferably, the blend of polypropylene and soft polymer additive in the tie-layer has two glass transition temperatures that are within the range of from −60° C. or −50° C. or −40° C. to −10° C. or 0° C. or +10° C. or +20° C. or +30° C.

The second tie-layer may contain metal-adhering ingredients as mentioned above, especially if it is the only layer adjacent to the core layer opposite of the first tie-layer, but may also contain other components as described herein. In a preferred embodiment, the second tie-layer is sandwiched between the core layer and a metal-accepting skin layer. Desirably, the second tie-layer comprises polypropylene, or a blend of polypropylene and a C₃/C₂/C₄ terpolymer.

The first tie-layer may also contain other additives, but in a preferred embodiment consists essentially of the soft polymer additive and polypropylene, and most preferably consists of the elastomer and polypropylene. As mentioned above, the first tie-layer is preferably sandwiched between a core layer and a sealable skin layer, thus, the sealable layer is preferably adjacent to the first tie-layer. In any case, the films of the invention have desirable sealability. Preferably, the inventive films have a seal strength (Hayssen) of at least 1100 or 1200 or 1500 g/inch at 125° C.

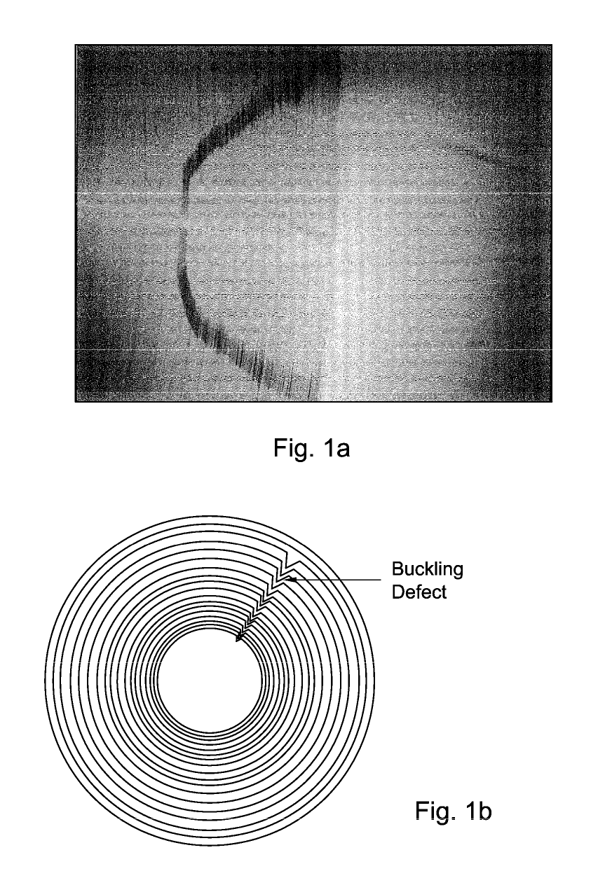

The films of the invention can of course be formed into a mill roll or “roll” as is known in the art. Thus, provided as another aspect of the invention is a method of transporting film comprising the inventive film; rolling the film onto a spool to form a roll; loading the roll onto a transport vehicle such as a truck, semi, plane, or ship at a geographic starting point; transporting the roll to a second geographic point, wherein the temperature change from the starting point to the second point is at least 5° C.; and unloading the roll at the second point having no starring or buckling such as demonstrated in comparative prior art film rolls shown in FIG. 1.

The inventive films can be used for many types of applications, including sealable films, and in particular, hermetic or air-tight packaging of articles. For packaging, the films are typically sealed at least partially or completely to itself, another film, or some other substrate. The sealing of the sealable films may be effectuated by any number of means well known in the art such as by heating, application of pressure, or other common means. Examples of its uses include candy wrappers, packaging for crackers, cereals, refrigerated goods, dairy products, and many other types of packing applications.

One or more experimental examples of the invention are described herein. These examples are meant to be non-limiting demonstrations of the unique features of the invention relative to the prior art.

### EXAMPLES

Most of the experiments and data in the examples relate to a 5-layer film having the structure D/A/C/B/E, wherein “C” is the core layer, “A” and “B” are tie-layers, “D” is the sealing or sealable layer, and “E” is the metallizable or metal-accepting layer. The film may or may not actually be metallized on the metal-accepting side of the sealable film. The inventive examples have the following film structure.

The “D” layer comprises Chisso 7796 terpolymer (Japan Polyolefins Corp.), which is a C₂/C₃/C₄ terpolymer having a melting point of 122° C. and a melt index of 5 g/10 min (ASTM 1238, 230° C./2.16 kg).

The “A” layer, or first tie-layer, comprises 35 wt %, by weight of the layer, of Vistamaxx (ExxonMobil), a propylene-α-olefin elastomer, having about 16 wt % ethylene-derived units (“high α-olefin elastomer”), a T_{g} of −32° C., and a melting point (DSC) of 102° C.; 35 wt %, by weight of the layer, ExxonMobil 4612 polypropylene homopolymer having a melt flow rate (ASTM D1238, 230° C., 2.16 kg) of about 3 g/10 min, a 1% Secant Modulus MD of about 119,000 psi and TD of about 116,000 psi, and a melting point (DSC) of about 161° C.; and 30 wt %, by weight of the layer, of Total 3571 polypropylene homopolymer having a MP of 163° C. and a melt flow rate (ASTM D1238, 230° C./2.16 kg) of 9.0 g/10 min.

The “C” layer comprises 80 wt %, by weight of the layer, of ExxonMobil 4872 polypropylene homopolymer having a melting point of 161° C., and a melt flow rate of 2.8 g/10 min; 5 wt %, by weight of the layer, of particles of PBT as a cavitating agent; and 15 wt % regrind whole film.

The “B” layer, or second tie-layer, comprises 47.5 wt %, by weight of the layer, of Total 3571 polypropylene homopolymer; 35 wt %, by weight of the layer, of Admer AT1179; and 22.5 wt %, by weight of the layer, of ExxonMobil 4612 polypropylene homopolymer.

The “E” layer comprises 96 wt %, by weight of the layer, of Eval G176B ethylene vinyl alcohol copolymer having a MP of 160° C.; and 4 wt %, by weight of the layer, of Ampecet™ 502486. This is a masterbatch of Eval G176B (99%) and Kynar Flex 2821 fluoropolymer process aid (1%).

The comparative examples are the same except that in layer “A” the propylene-α-olefin copolymer is a Vistamaxx having about 9 wt % ethylene-derived units (“low α-olefin elastomer”), a T_{g} of -19° C. and a melting point (DSC) of 79° C.

Test Methods include measuring the “percent crystallinity” using DSC based on the total enthalpy of the crystalline melting endoderm; and glass transition temperature was measured using the Dynamic Mechanical Analysis (DMAT), where the peaks in the delta tangent (or “Tan δ”) curve are used to determine Tg. The DMAT tests were done according as described in the Examples. The instrument used was a Rheometric Scientific DMTA V, the test is conducted at 1 Hz, with a strain of 0.05% and a temperature ramp rate of 2° C. per minute from −40 to sample melt point.

The comparative film is a cavitated white ultra-high barrier, enhanced-sealable film. The elastomeric component can be added to the core if necessary to enhance sealant characteristics. While the elastomer in the comparative film provides the necessary characteristics to achieve good acceptable performance, such as good seal strength of at least about 1000 g/in and machinability on Bartell flat pouch machines, it also has a higher variation of complex modulus with temperature higher miscibility with polypropylene and results in slower crystallization rates of the polypropylene and soft polymer blend. All of these characteristics are hypothesized to contribute to poorer roll geometry as manifested by increased starring and TD buckling under high temperature conditions. This is demonstrated visually by the picture in FIGS. 1(a) and (b).

FIGS. 1(a) and (b) are an end view of the wound comparative film showing a scalloped or starred appearance. This is manifested as a result of the roll buckling in the transverse direction. Film appears creased or wrinkled at the points of wound layer dislocation making it unusable by converters. Buckling occurs when air between film layers in the roll escapes and if film shrinks after winding as a result of change in the mechanical properties of the film during storage or processing. This can occur due to secondary crystallization while the roll is in storage or due to a change in modulus as a result of high processing temperature.

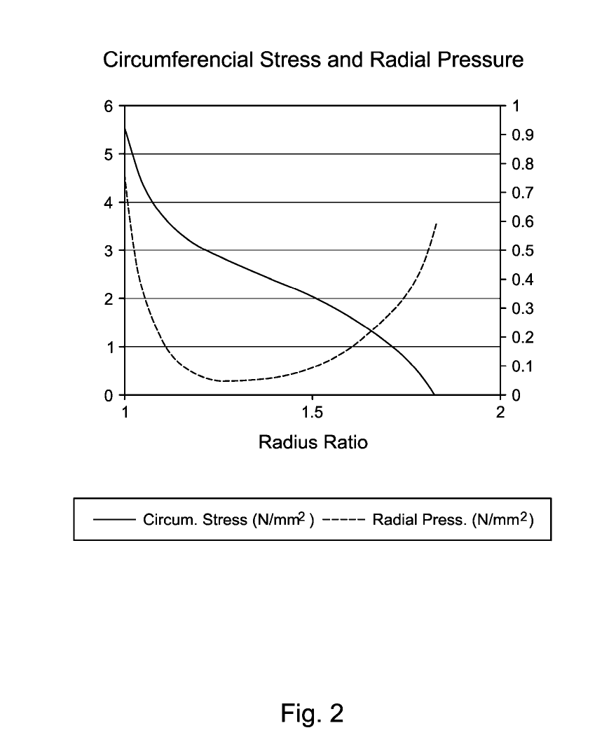

Any roll of film that is wound has two components of stress: Radial Pressure and Circumferential Stress, shown graphically in FIG. 2. Radial Pressure is the compression that will try to deform the lower layers in a roll. Radial Pressure is always positive—starting at its highest value in the first few wraps on the core, dropping fairly quickly to some moderate value through most of the middle of the roll, and then dropping off to zero at the very outside of the roll.

As for circumferential stress, every layer of film that is wound onto a roll is initially under positive tension. But each subsequent layer being wound onto the roll creates stress in the radial direction causing the lower layers to change dimensionally. This dimensional change actually creates negative circumferential stress/tension (layers approach zero tension and can actually be under MD compression) throughout most of the middle part of the roll. Circumferential stress is usually a U-shape when modeled as in FIG. 2, being high near the core (because the core can't compress) and at the end of the roll (where there is very little radial pressure), but near zero or negative throughout most of the roll. One condition that is very common is gauge related, where the “softer” area of the roll tends to buckle because the underlying layers have no support from the radial compressive forces. The variation of modulus with temperature or the change in crystallinity during storage results in varying areas of hardness in the rolls resulting in a change in the radial pressure and, hence, buckling is seen in the comparative example but not seen in the inventive films.

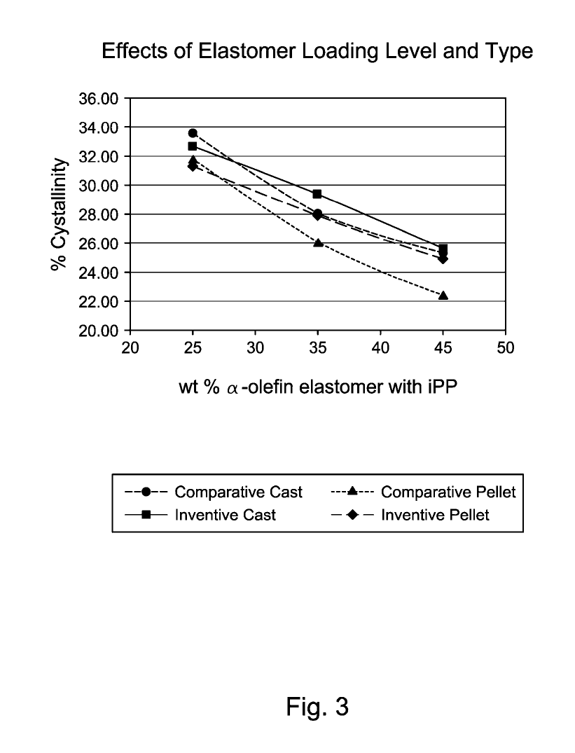

FIG. 3 shows the crystallization behavior of comparative film versus the inventive film structure. Extruded pellets and un-metallized cast sheet samples of polypropylene-propylene-α-olefin elastomer blends were prepared with varying loadings of the two elastomer grades. These sheet samples were then run through a DSC calorimeter to evaluate percent crystallinity versus loading level. The data show that for higher elastomer loadings, the inventive example film exhibits a higher level of crystallinity compared to the comparative film. DSC traces also show that the crystallization rate is faster for inventive film compared to the comparative film.

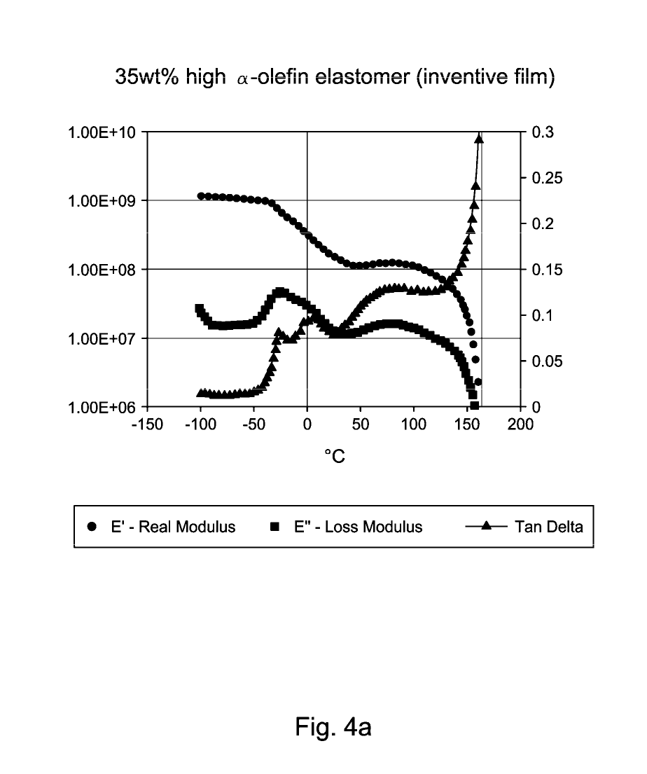

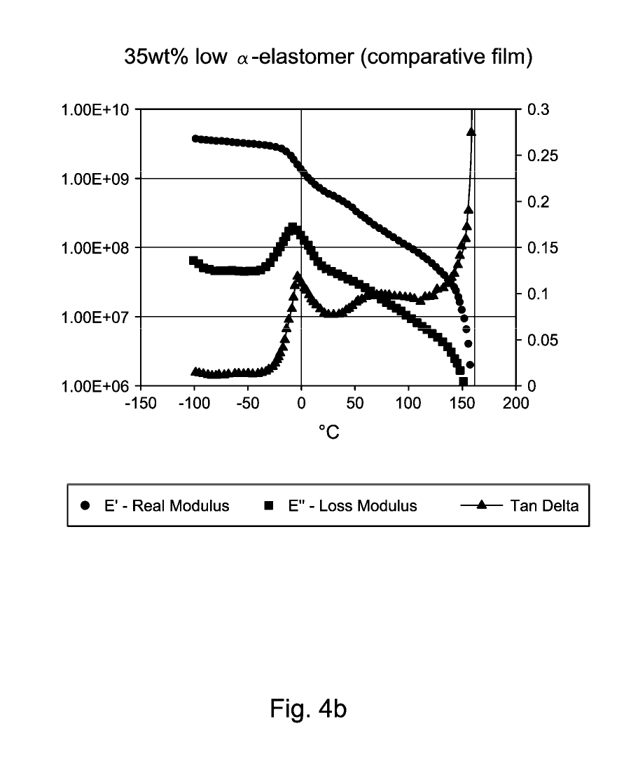

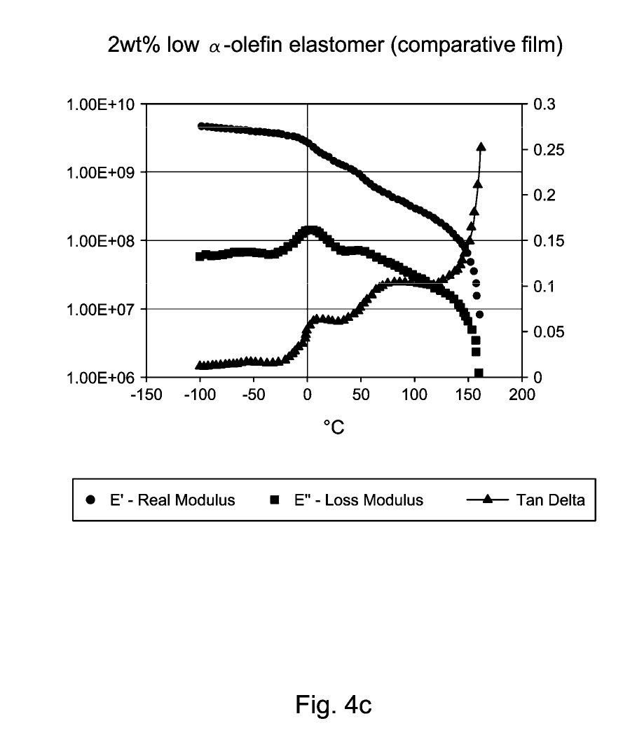

FIGS. 4(a) to (c) show the dynamic mechanical thermal behavior of un-metallized inventive and comparative cast film sheets using Dynamic Mechanical Thermal Analysis (DMTA). FIG. 4(a) (35 wt % high α-olefin elastomer in the tie-layer) shows the following characteristics:
a) 2 peaks in the tan δ plot, which is an indicator that two glass transition temperatures (Tg's) are present implying that the elastomer of the inventive film is immiscible or has a lower miscibility with the polypropylene phase;
b) Gentler slope at the peak or Tg in the tan δ plot indicating decrease magnitude of change in mechanical properties at the Tg; and
c) Gentler slope in the modulus versus temperature plot indicating less reduction of modulus with temperature.

The DMTA measurements are carried out as described by E. A. Turi in I THERMAL CHARACTERIZATION OF POLYMERIC MATERIALS (2^{nd} Ed., Academic Press 1997). Generally, after scanning the sample under test, either the viscoelastic moduli, storage moduli, loss modulus, damping properties, and tan delta, one or more of these parameters is used to define the Tg. The ramp temperature rate was 5° C./min. The tan δ peak occurs at the highest temperature. The instrument used in the DMTA was a Rheometric Scientific DMTA V, the test is conducted at 1 Hz, with a strain of 0.05% and a temperature ramp rate of 2° C. per minute from −40 to sample melt point. Precision: Temperature: ±2° C.

FIG. 4(b) (35% of the low α-olefin elastomer) on the other hand, shows the following characteristics:
a) 1 peak in the tan δ plot, which is an indicator that one glass transition temperature (Tg) is present, implying that the elastomer in the comparative film is miscible with the polypropylene phase;
b) Steeper slope at the peak or Tg in the tan δ plot indicating increased magnitude of change in mechanical properties at the Tg; and
c) Increased slope in the modulus versus temperature plot indicating rapid reduction of modulus with temperature.

FIG. 4(c) shows the DMTA plot with mostly all polypropylene homopolymer in the tie-layer. Under normal metallization processing conditions, the comparative film is thus expected to change properties more than the inventive film. This has been confirmed through initial tests with the inventive film where minimal to no starring and buckling was observed in the rolls. Thus, the elastomer choice for the tie-layer should be one that has results in a film structure exhibiting low change in mechanical properties at the Tg and that has 2 distinct Tg's or at least a broadened Tg.

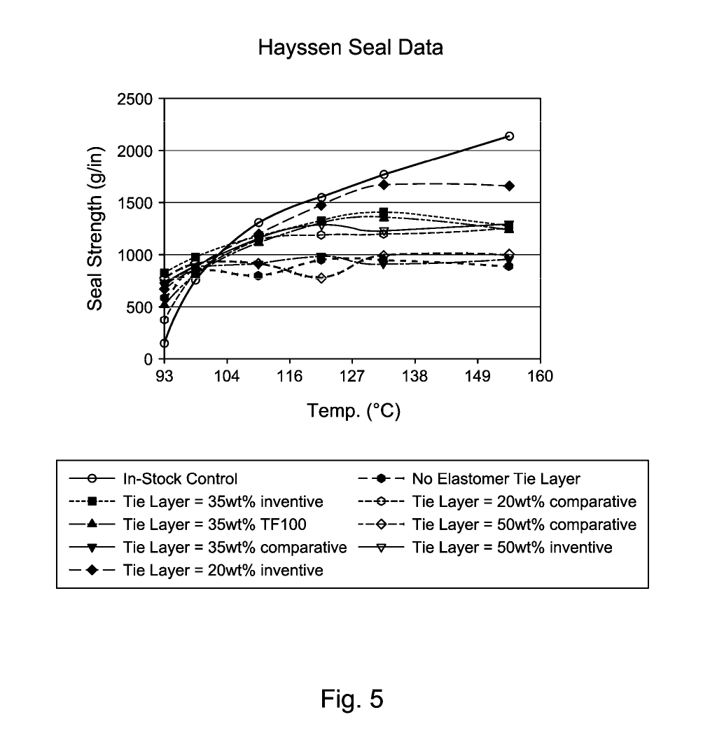

The sealability of the inventive and comparative films was investigated. FIGS. 5 to 7 show sealability data for various un-metallized comparative and inventive film structures laminated to another OPP film. No elastomer or high crystallinity polypropylene was used in the core layer of the inventive film. Sealability was measured using the Hayssen packaging machine.

Hayssen Conditions: Horizontal crimp jaw design
72 empty/65 filled ppm
14″ long×5¼″ wide pkg layflat
Velcro “wool” back up pad
½ inch platen gap

Bartelt Conditions: Speed=35 fpm/84 ppm
Pouch Type=Gusset
Pouch size=5″ wide×5¼″ high
Steel/rubber side seal
Cooling bars after heated side seals

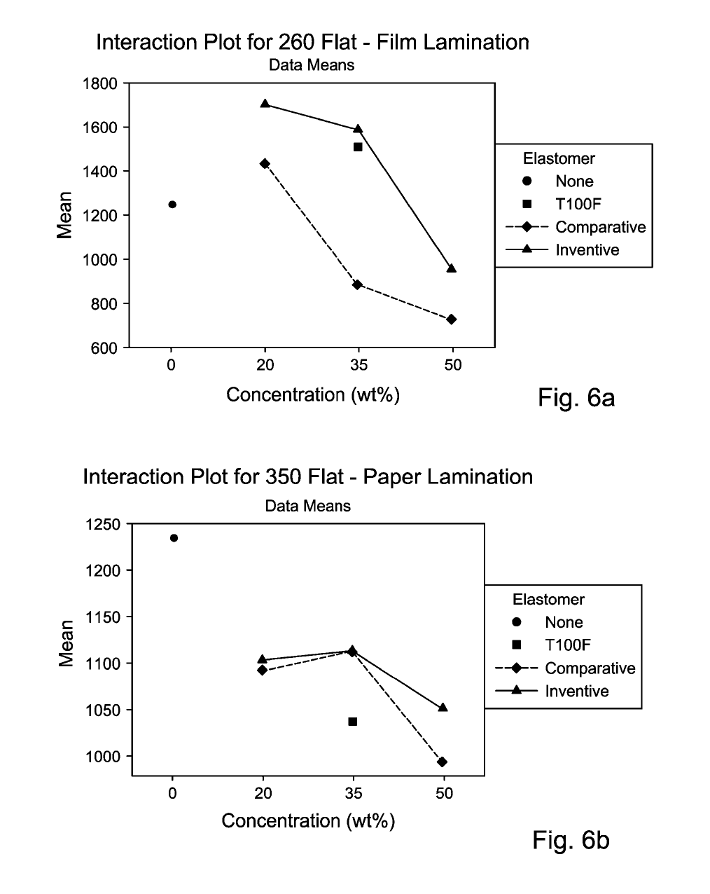

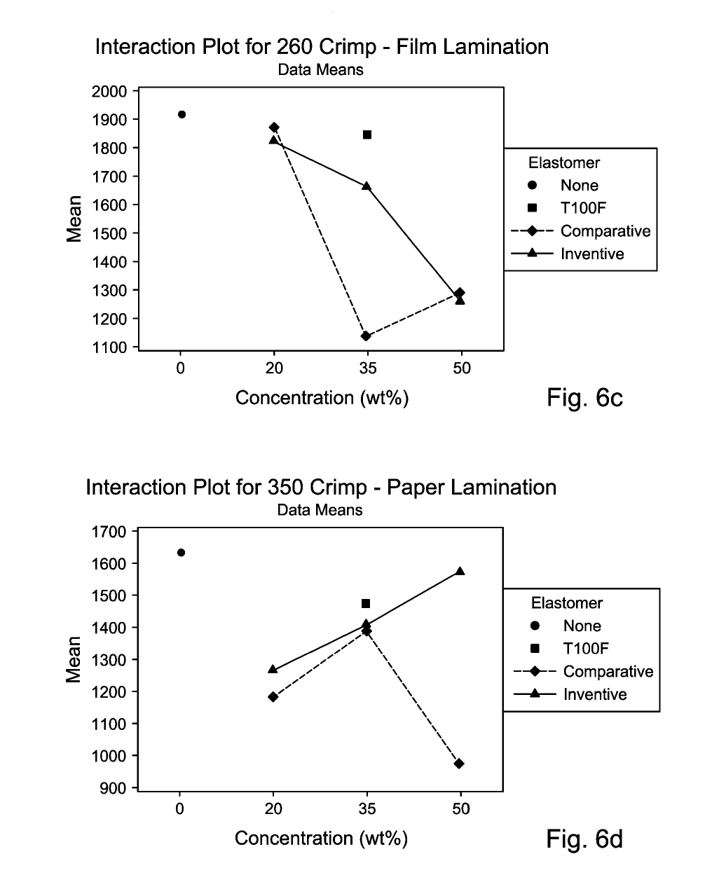

The data in FIG. 5 demonstrates that for a comparable loading (35 wt %) of high α-olefin elastomer as compared to loading with the low α-olefin elastomer in the tie-layer of the film, a higher seal strength was obtained. In fact when the loading of Vistamaxx in the inventive film was lowered to 20 wt %, the sealability at temperatures greater than 260° F. (127° C.) appeared to be better than that of comparative film loaded at 35 wt % low α-olefin elastomer. The “T100F” data here and in FIG. 6 is for comparable films made using the elastomer Adflex T100F (Total), which has a softening point of 55° C. (ISO 306).

Additional sealability data measured using the laboratory Lako seal tester with flat jaws and Wrapade Crimp Seal testers are shown in FIG. 6. These data corroborate the observations on the Hayssen that the inventive film results in stronger seals as compared with the comparative film. The variation of the sealability of the film with elastomer concentration in the inventive film depends on the temperature at which the Lako Flat Jaw or Wrapade Crimp Seal Tester was operated. In practice there may be a wide variety of operating conditions used for sealing.

Another experiment was conducted to explore the lower range of elastomer loading in the inventive film to determine what the optimum concentration was, based on sealability and cost. The results of this experiment are shown in FIG. 5. Based on these results, it was determined that the optimum concentration high α-olefin elastomer to use was about 15 wt % to 20 wt % in the tie-layer. An average of measurements at 250° F. (121° C.), 270° F. (132° C.) and 310° F. (154° C.) was used to determine the overall impact on sealability.

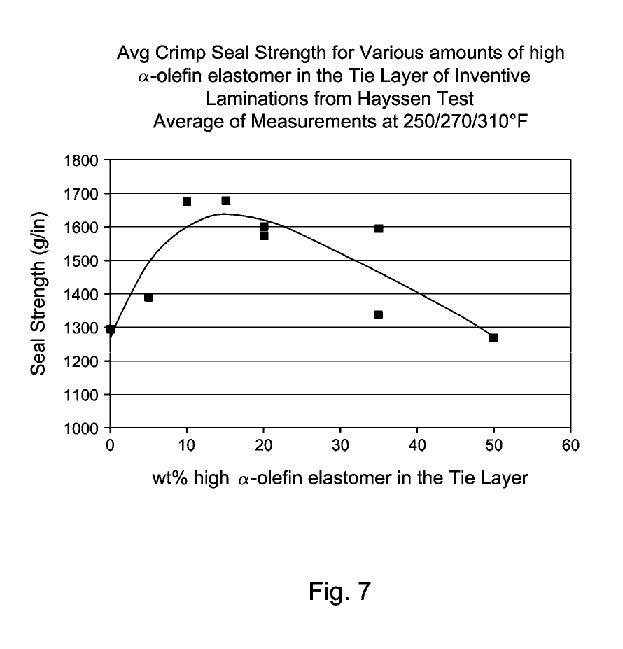

Finally, the seal failure mechanisms between inventive films (having varying amounts of high α-olefin elastomer) in FIG. 7 and those based on the comparative film was explored based on the miscibility data cited above and based on observation of the failed samples. It was concluded that the comparative films had a single point failure in the tie-layer whereas the inventive films failed in multiple locations where tear propagation was arrested locally via a fail and heal mechanism, resulting in a stronger overall seal performance.

Having described the various features of the inventive films, tie-layer compositions and method of transporting a roll of such a film comprising the inventive tie-layer, described here in numbered embodiments is:

1. A multi-layered sealable film comprising:

(a) a core layer comprising polypropylene sandwiched between at least a first and, optionally, a second tie-layer, on either side of the core;

(b) a sealable layer with two sides, one side adhered to the first tie-layer;

wherein at least the first tie-layer comprises a blend of polypropylene and within the range of from 5 wt % or 10 wt % to 20 wt % or 30 wt % or 40 wt % of a soft polymer additive, by weight of the first tie-layer, wherein the blend of polypropylene and soft polymer additive is a heterogeneous blend characterized in having two glass transition temperatures (Tg) that are within the range of from −60° C. or −50° C. or −40° C. to −10° C. or 0° C. or +10° C. or +20° C. or +30° C.

2. A multi-layered sealable film comprising:

(a) a core layer comprising polypropylene sandwiched between at least a first and second tie-layer on either side of the core;

(b) a sealable layer with two sides, one side adhered to the first tie-layer;

wherein at least the first tie-layer comprises a blend of polypropylene and within the range of from 5 wt % or 10 wt % to 20 wt % or 30 wt % or 40 wt % of a propylene-α-olefin elastomer, by weight of the first tie-layer, having within the range of from 10 wt % or 12 wt % or 14 wt % to 25 wt % or 30 wt % α-olefin derived units.

3. The film of numbered embodiment 1 or 2, wherein the film comprises first and second tie-layers which are asymmetric.
4. The film of numbered embodiment 3, wherein the second tie-layer is also adjacent to a metal-accepting skin layer.
5. The film of numbered embodiment 4, wherein the propylene-α-olefin elastomer is substantially absent from the second tie-layer.
6. The film of numbered embodiment 4, wherein the metal-accepting skin layer comprises a polar-functionalized polymer.
7. The film of numbered embodiment 2, wherein the blend of polypropylene with the propylene-α-olefin elastomer in the first tie-layer is heterogeneous.
8. The film of any one of the previous numbered embodiments, wherein the amount of soft polymer additive or propylene-α-olefin elastomer present in the core layer is less than 5 wt % or 3 wt % or 1 wt %, by weight of the core layer; wherein propylene-α-olefin elastomer is substantially absent from the core layer.
9. The film of any one of the previous numbered embodiments, wherein the melting point of the soft polymer additive or propylene-α-olefin elastomer by DSC is within the range of from 30° C. or 40° C. or 50° C. or 60° C. to 105° C. or 110° C. or 115° C.
10. The film of any one of the previous numbered embodiments, wherein the glass transition temperature of the soft polymer additive or propylene-α-olefin elastomer is within the range of from −50° C. or −40° C. to −10° C. or 0° C.
11. The film of any one of the previous numbered embodiments, wherein the crystallinity of the blend of soft polymer additive or polypropylene and propylene-α-olefin elastomer in the first tie-layer is within the range of from 20% or 22% or 24% or 26% to 30% or 32% or 34% or 36%.
12. The film of any one of the previous numbered embodiments, wherein the blend of polypropylene and soft polymer additive or propylene-α-olefin elastomer in the first tie-layer has one glass transition temperature (Tg) that is within the range of from −50° C. or −40° C. to −10° C. or 0° C. or +10° C. or +20° C.
13. The film of any one of the previous numbered embodiments, wherein the blend of polypropylene and soft polymer additive or propylene-α-olefin elastomer in the first tie-layer has two glass transition temperatures (Tg) that are within the range of from −60° C. or −50° C. or −40° C. to −10° C. or 0° C. or +10° C. or +20° C. or +30° C.
14. The film of any one of the previous numbered embodiments, wherein the sealable layer is adjacent to the first tie-layer.
15. The film of any one of the previous numbered embodiments, wherein the film has a seal strength (Hayssen) of at least 1100 or 1200 or 1500 g/inch at 125° C.
16. An article wrapped or packaged in the film of any one of the previous numbered embodiments, wherein the film is sealed.
17. A roll of film comprising the film of any one of the previous numbered embodiments.
18. A method of transporting film comprising:

(a) providing the film of any one of the previously numbered embodiments 1 to 15;

(b) rolling the film onto a spool to form a roll;

(c) loading the roll onto a transport vehicle at a geographic starting point;

(d) transporting the roll to a second geographic point, wherein the temperature change from the starting point to the second point is at least 5° C.; and

(e) unloading the roll at the second point having no starring or buckling.

Also provided is the use of the multi-layered film as described in any of the previous numbered embodiments 1 to 15 to form packaging for an article.

Also provided is the use of the multi-layered film in packaging of articles in any one of the previous numbered embodiments 1 to 15.

1. A multi-layered sealable film comprising:
(a) a core layer comprising polypropylene sandwiched between at least a first and, optionally, a second tie-layer, on either side of the core;
(b) a sealable layer with two sides, one side adhered to the first tie-layer;
wherein at least the first tie-layer comprises a blend of polypropylene and within the range of from 5 wt % to 40 wt % of a soft polymer additive, by weight of the first tie-layer, wherein the blend of polypropylene and soft polymer additive is a heterogeneous blend characterized in having two glass transition temperatures (Tg) that are within the range of from −60° C. to +30° C.

2. A multi-layered sealable film of claim 1, wherein at least the first tie-layer comprises a blend of polypropylene and within the range of from 5 wt % to 40 wt % of a propylene-α-olefin elastomer, by weight of the first tie-layer, having within the range of from 10 wt % to 30 wt % α-olefin derived units.

3. The film of claim 2, wherein the film comprises first and second tie-layers on both sides of the core layer which are asymmetric.

4. The film of claim 3, wherein the second tie-layer is also adjacent to a metal-accepting skin layer.

5. The film of claim 4, wherein the propylene-α-olefin elastomer is substantially absent from the second tie-layer.

6. The film of claim 2, wherein the blend of polypropylene with the propylene-α-olefin elastomer in the first tie-layer is heterogeneous.

7. The film of claim 2, wherein the amount of propylene-α-olefin elastomer present in the core layer is less than 5 wt % or 3 wt % or 1 wt %, by weight of the core layer;
wherein propylene-α-olefin elastomer is substantially absent from the core layer.

8. The film of claim 2, wherein the melting point of the propylene-α-olefin elastomer by DSC is within the range of from 30° C. to 115° C.

9. The film of claim 2, wherein the glass transition temperature of the propylene-α-olefin elastomer is within the range of from −50° C. to 0° C.

10. The film of claim 2, wherein the crystallinity of the blend of polypropylene and propylene-α-olefin elastomer in the first tie-layer is within the range of from 20% to 36%.

11. The film of claim 2, wherein the blend of polypropylene and propylene-α-olefin elastomer in the first tie-layer has one glass transition temperature (Tg) that is within the range of from −50° C. to +20° C.

12. The film of claim 2, wherein the blend of polypropylene and propylene-α-olefin elastomer in the first tie-layer has two glass transition temperatures (Tg) that are within the range of from −60° C. to +30° C.

13. The film of claim 2, wherein the sealable layer is adjacent to the first tie-layer.

14. The film of claim 14, wherein the film has a seal strength (Hayssen) of at least 1100 g/inch at 125° C.

15. A roll of film comprising the film of claim 2.

16. A method of transporting film comprising:
(a) providing a film;
(b) rolling the film onto a spool to form a roll;
(c) loading the roll onto a transport vehicle at a geographic starting point;
(d) transporting the roll to a second geographic point, wherein the temperature change from the starting point to the second point is at least 5° C.;
(e) unloading the roll at the second point having no starring or buckling; and
(f) wherein the film comprises:
1) a core layer comprising polypropylene sandwiched between at least a first and, optionally, a second tie-layer, on either side of the core;
2) a sealable layer with two sides, one side adhered to the first tie-layer;
3) wherein at least the first tie-layer comprises a blend of polypropylene and within the range of from 5 wt % to 40 wt % of a propylene-α-olefin elastomer, by weight of the first tie-layer, and having within the range of from 10 wt % to 30 wt % α-olefin derived units.

17. The method of claim 17, wherein the film comprises asymmetric tie-layers on both sides of the core layer.

18. The film of claim 18, wherein the second tie-layer is also adjacent to a metal-accepting skin layer.

19. The film of claim 17, wherein the blend of polypropylene with the propylene-α-olefin elastomer in the first tie-layer is heterogeneous.

20. The film of claim 17, wherein the amount of propylene-α-olefin elastomer present in the core layer is less than 5 wt %, by weight of the core layer; wherein propylene-α-olefin elastomer is substantially absent from the core layer.

21. The film of claim 17, wherein the melting point of the propylene-α-olefin elastomer by DSC is within the range of from 30° C. to 115° C.

22. The film of claim 17, wherein the glass transition temperature of the propylene-α-olefin elastomer is within the range of from −50° C. to 0° C.

23. The film of claim 17, wherein the crystallinity of the blend of polypropylene and propylene-α-olefin elastomer in the core layer is within the range of from 20% to 36%.

24. The film of claim 17, wherein the blend of polypropylene and propylene-α-olefin elastomer in the core layer has one glass transition temperature that is within the range of from −50° C. to +20° C.

25. The film of claim 17, wherein the blend of polypropylene and propylene-α-olefin elastomer in the core layer has two glass transition temperatures that are within the range of from −60° C. to +30° C.
